(19) United States
(12) Patent Application Publication
(10) Pub. No.: US 2008/0023883 A1
(43) Pub. Date: Jan. 31, 2008

(54) Pneumatic structure

(75) Inventor: Gerry Ha, Vaughan (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, US

(73) Assignee: Husky Injection Molding Systems Ltd.

(21) Appl. No.: 11/493,465

(22) Filed: Jul. 26, 2006

(51) Int. Cl. B29C 45/43; B29C 49/64

(52) U.S. Cl. 264/328.1; 425/547; 425/556; 264/335

(57) ABSTRACT

Disclosed, amongst other things, is: (i) a pneumatic structure (160) for a post-mold device (15) comprising a control valve (162, 170, 172) configured to alternately pneumatically connect a holder (150) of the post-mold device (15) to one of: a first vacuum source (164) and a second vacuum source (166); (ii) a method of a post-mold device in a molding system, the method includes configuring the control valve (162, 170, 172) for alternately pneumatically connecting the holder (150) of the post-mold device between the first vacuum source 164 and to the second vacuum source (166); (iii) the post-mold device (15) including the holder (150) and the pneumatic structure (160); and (iv) a molding system (10) including the post-mold device (15) having the holder (150) and the pneumatic structure (160).

### TECHNICAL FIELD

The present invention generally relates to, but is not limited to, a post-mold device of a molding system, and more specifically the present invention relates to, but is not limited to: (i) a pneumatic structure of the post-mold device; (ii) a molding system having a pneumatic structure of a post-mold device; and/or (iii) a method of controlling a pneumatic structure for the post-mold device; amongst other things.

### BACKGROUND

Some injection molded articles, for example plastic preforms of the variety that are for blow molding into beverage bottles, require extended cooling periods to solidify into substantially defect-free molded articles. To the extent that the cooling of the molded article can be effected outside of the injection mold by one or more post-mold devices then the productivity of the injection mold may be increased (i.e. lower cycle time). A variety of such post-mold devices, and related methods, are known and have proven effective at the optimization of the injection molding machine cycle time.

In a typical injection molding system, such as the system 10 depicted with reference to FIG. 1, and as generally described in commonly assigned United States patent publication 2004/0185136 (Inventor: DOMODOSSOLA, Robert, et al.; Published: published 23^{rd} Sep. 2004), just-molded, and hence partially cooled, molded articles 2 are ejected from the mold half 8, when the mold halves 8, 9 are spaced apart, and into molded article holders 50 (i.e. commonly known as a cooling tube, a take-off tube, or a cooling pipe, amongst others). The holders 50 are arranged on a post-mold device 15 (i.e. commonly known as an end-of-arm-tool, carrier plate assembly, removal device, post-cooling apparatus, amongst others), the post-mold device 15 configured to cyclically position the holders 50, arranged on a supporting plate 16, between an in-mold position between the mold halves 8, 9, to receive the molded articles 2, and an outboard position, as depicted, to allow the mold halves 8, 9 to close and begin another molding cycle. Preferably, the molded articles 2 are held in the holders 50 until the molded articles 2 have cooled sufficiently so that they may be ejected without risk of further deformation. As depicted, the post-mold device 15 provides for multi-stage cooling of the molded articles 2. That is, the multi-stage post-mold device 15 includes an arrangement of holders 50 that accommodates multiple shots of molded articles produced, per cycle, by the molding device, as generally described in commonly assigned U.S. Pat. No. RE33,237 (Inventor: DEFLER, Frank; Published: 19^{th} Jun., 1990).

The molding system 10 also includes a pneumatic structure 60. As shown in detail with reference to FIG. 2, the pneumatic structure 60 controllably connects, via control valves 62-1, 62-2, 62-3, 72, a pressure channel 51, configured in the base of the holders 50 of a multi-stage post-mold device 15, to one of: a vacuum source 66; a pressure source 76; or an atmospheric pressure source 74, whereby a pressure induced mobility of the molded article 2 with respect to a cavity defined by the holder 50 may be effected.

The molding machine 10 also includes a controller 30, such as that described in commonly assigned U.S. Pat. No. 6,275,741 (Inventor: CHOI, Christopher; Published: 14th Aug., 2001), for controlling machine-control functions including the operation of the post-mold device 15 and the pneumatic structure 60.

The cooling of the molded articles 2 may be assisted by the use of pins 14 for expelling a cooling fluid onto an inner portion of the molded articles 2. The pins 14 are arranged on another post-mold device 12 (i.e. commonly known as a COOLJET, a trademark of Husky Injection Molding Systems Ltd.), the post-mold device 12 arranged to be cyclically positioned between a cooling position, with the pins 14 positioned adjacent the portion of the molded articles 2, and an outboard position, as depicted. It is also, known to use the molded article post-mold device 12 to extract the molded articles 2 from the holders 50 for a re-handling thereof, for instance, to a conveyor.

Alternatively, the post-mold device 15 may be configured to include the holder 50 of commonly assigned U.S. Pat. No. 6,951,453 (Inventor: NETER, Witold, et al.; Published: 4^{th} Oct., 2005). In particular, the holder 50 includes a porous member having an inside surface that is profiled to substantially reflect a shape of a portion of an outside surface of the molded article to be cooled, and a coupling structure for connecting the porous member to a pneumatic structure, whereby a reduced pressure may be provided adjacent the inside surface of the porous member to cause a hot, malleable, portion of the outside surface of the molded article to contact the inside surface of the porous member so as to cool in conformance therewith and thereby avoid the formation of cooling related defects in the molded article.

With the holders 50 in accordance with U.S. Pat. No. 6,951,453, and the like, it is preferred to configure the pneumatic structure to avoid pressure variations in the holder 50 that might otherwise permit a premature loss of contact between the outside surface of the molded article 2 and the inside surface of the porous member, that is, until the molded article portion has been cooled sufficiently that its shape, once removed from the holder 50, is preserved. A potential consequence of the premature loss of contact may be cooling related defects, for example, when molding preforms, of the type used for blow molding into bottles, annular body portions of the preform may be rendered oval as a result of uneven cooling and support between the outside surface of the annular preform portion and the inside surface of the holder 50. Accordingly, with the multi-stage post-mold device 15 it may be necessary to configure the pneumatic structure to include a dedicated vacuum tank for each stage of holders, whereby a vacuum pressure variation imparted by the introduction, or ejection, of the molded articles into, or from, the holders 50 of one stage does not effect the vacuum pressure in the remaining stages. Unfortunately, the foregoing pneumatic structure, with its dedicated vacuum tank per stage, is quite costly.

### SUMMARY

According to a first aspect of the present invention, there is provided a pneumatic structure of a post-mold device. The pneumatic structure includes a control valve configured to alternately pneumatically connect a holder of the post-mold device to one of: a first vacuum source; and a second vacuum source.

According to a second aspect of the present invention, there is provided a method of operating a pneumatic structure of a post-mold device. The method includes configuring a control valve for alternately pneumatically connecting a holder of the post-mold device between a first vacuum source and to a second vacuum source.

According to a third aspect of the present invention, there is provided a post-mold device. The post-mold device including a molded article holder, and a pneumatic structure. The pneumatic structure including a controllable valve configured to alternately pneumatically connect the post-mold device between a first vacuum source and to a second vacuum source.

According to a fourth aspect of the present invention, there is provided a molding system. The molding system including a post-mold device and a pneumatic structure. The post-mold device including a holder. The pneumatic structure, including a controllable valve configured to alternately pneumatically connect the post-mold device between a first vacuum source and to a second vacuum source.

A technical effect, amongst others, of the aspects of the present invention may include a relatively constant vacuum pressure in the holder to avoid cooling related defects in the molded article.

Another technical effect, amongst others, of the aspects of the present invention is a cost effective pneumatic structure for a post-mold device.

### BRIEF DESCRIPTION OF THE DRAWINGS

A better understanding of the exemplary embodiments of the present invention (including alternatives and/or variations thereof) may be obtained with reference to the detailed description of the exemplary embodiments along with the following drawings, in which:

FIG. 1 is a is a top elevation view of a known injection molding system;

FIG. 2 is a schematic of a known pneumatic structure connected to empty holders of a multi-stage post-mold device;

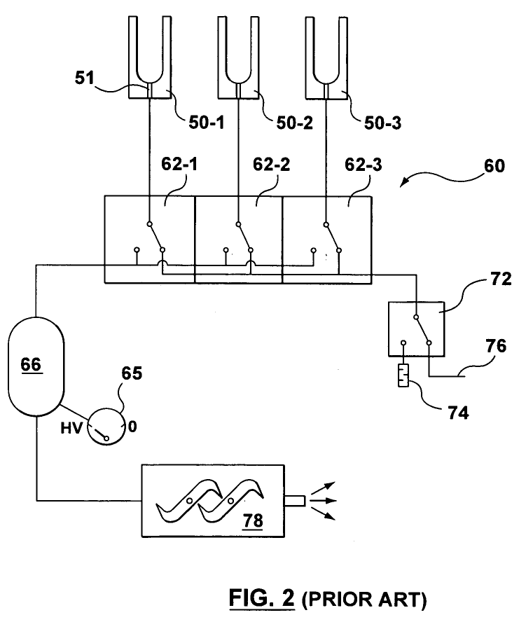

FIG. 3 is a schematic of a pneumatic structure in accordance with an exemplary embodiment of the present invention connected to empty holders of a multi-stage post-mold device, prior to a startup thereof;

FIG. 4 is a schematic of the pneumatic structure of FIG. 3 as configured to connect the empty holders of the multi-stage post-mold device to a pressure source, during start-up operation;

FIG. 5 is a schematic of the pneumatic structure of FIG. 3 as configured prior to a transfer of a molded article into the holder of a first stage of the post-mold device, during start-up operation;

FIG. 6 is a schematic of the pneumatic structure of FIG. 3 as configured during the transfer of the molded article into the holder of a first stage of the post-mold device, during start-up operation;

FIG. 7 is a schematic of the pneumatic structure of FIG. 3 as configured after the receipt of the molded article into the holder of the first stage of the post-mold device, during start-up operation;

FIG. 8 is a schematic of the pneumatic structure of FIG. 3 as configured to connect the empty holders of a second and third stage of the post-mold device to a pressure source, during start-up operation;

FIG. 9 is a schematic of the pneumatic structure of FIG. 3 as configured prior to a transfer of a molded article into the holder of the second stage of the post-mold device, during start-up operation;

FIG. 10 is a schematic of the pneumatic structure of FIG. 3 as configured during the transfer of the molded article into the holder of the second stage of the post-mold device, during start-up operation;

FIG. 11 is a schematic of the pneumatic structure of FIG. 3 as configured after the receipt of the molded article into the holder of the second stage of the post-mold device, during start-up operation;

FIG. 12 is a schematic of the pneumatic structure of FIG. 3 as configured to connect the empty holder of the third stage of the post-mold device to a pressure source, during start-up operation;

FIG. 13 is a schematic of the pneumatic structure of FIG. 3 as configured prior to a transfer of a molded article into the holder of the third stage of the post-mold device, during start-up operation;

FIG. 14 is a schematic of the pneumatic structure of FIG. 3 as configured during the transfer of the molded article into the holder of the third stage of the post-mold device, during start-up operation;

FIG. 15 is a schematic of the pneumatic structure of FIG. 3 as configured after the receipt of the molded article into the holder of the third stage of the post-mold device, during start-up operation;

FIG. 16 is a schematic of the pneumatic structure of FIG. 3 as configured to connect the holder of the first stage of the post-mold device to the pressure source as the molded article is ejected therefrom, during normal operation;

FIG. 17 is a schematic of the pneumatic structure of FIG. 3 as configured prior to a transfer of a next molded article into the holder of the first stage of the post-mold device, during normal operation;

FIG. 18 is a schematic of the pneumatic structure of FIG. 3 as configured during the transfer of the next molded article into the holder of the first stage of the post-mold device, during normal operation;

FIG. 19 is a schematic of the pneumatic structure of FIG. 3 as configured after the receipt of the molded article into the holder of the first stage of the post-mold device, during normal operation;

FIG. 20 is a schematic of the pneumatic structure of FIG. 3 as configured to connect the holder of the second stage of the post-mold device to the pressure source as the molded article is ejected therefrom, during normal operation;

FIG. 21 is a schematic of the pneumatic structure of FIG. 3 as configured prior to a transfer of a next molded article into the holder of the second stage of the post-mold device, during normal operation;

FIG. 22 is a schematic of the pneumatic structure of FIG. 3 as configured during the transfer of the next molded article into the holder of the second stage of the post-mold device, during normal operation;

FIG. 23 is a schematic of the pneumatic structure of FIG. 3 as configured after the receipt of the molded article into the holder of the second stage of the post-mold device, during normal operation;

FIG. 24 is a schematic of the pneumatic structure of FIG. 3 as configured to connect the holder of the third stage of the post-mold device to the pressure source as the molded article is ejected therefrom, during normal operation;

FIG. 25 is a schematic of the pneumatic structure of FIG. 3 as configured prior to a transfer of a next molded article into the holder of the third stage of the post-mold device, during normal operation;

FIG. 26 is a schematic of the pneumatic structure of FIG. 3 as configured during the transfer of the next molded article into the holder of the third stage of the post-mold device, during normal operation;

FIG. 27 is a schematic of the pneumatic structure of FIG. 3 as configured after the receipt of the molded article into the holder of the third stage of the post-mold device, during normal operation.

The drawings are not necessarily to scale and are may be illustrated by phantom lines, diagrammatic representations and fragmentary views. In certain instances, details that are not necessary for an understanding of the exemplary embodiments or that render other details difficult to perceive may have been omitted.

### DETAILED DESCRIPTION OF THE EXEMPLARY EMBODIMENTS

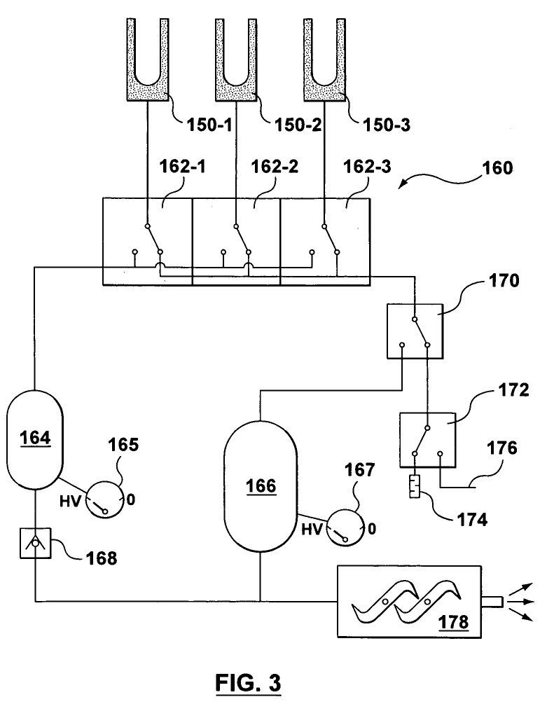

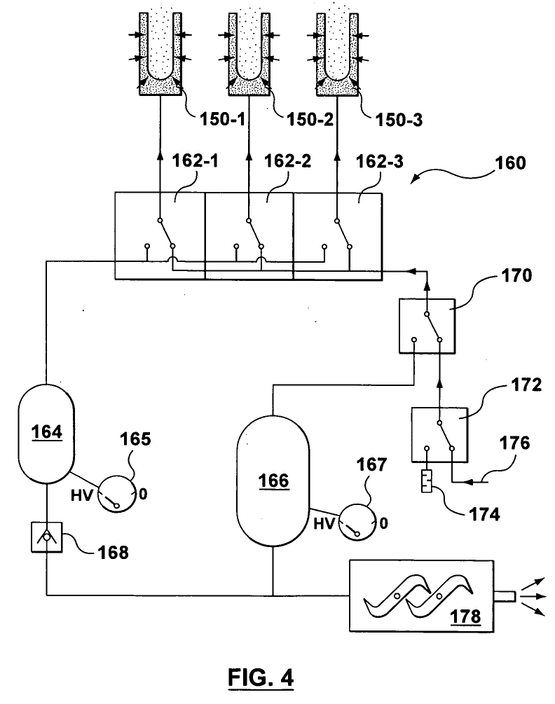

FIG. 3 is a schematic representation of a pneumatic structure 160 according to a first exemplary embodiment connected with empty holders 150-1, 150-2, 150-3 of a multi-stage post-mold device (i.e. holder 150-1 is from the first stage of the post-mold device, holder 150-2 is from the second stage of the post-mold device, and holder 150-3 is from the third stage of the post-mold device). The pneumatic structure 160 is shown as configured prior to a startup operation of the post-mold device. The holders 150-1, 150-2, 150-3 are preferably configured in accordance with U.S. Pat. No. 6,951,453, as described hereinbefore. Accordingly, the holders 150-1, 150-2, 150-3 each includes a porous member having an inside surface that is profiled to substantially reflect a shape of a portion of an outside surface of a molded article 2 (shown with reference to FIGS. 4 through 27) to be cooled. The holders 150-1, 150-2, 150-3 each include a coupling structure (not shown) for connecting the porous member to the pneumatic structure 160, whereby pneumatic pressure may be controlled (i.e. above or below ambient) adjacent the inside surface of the porous member.

The pneumatic structure 160 preferably includes a first vacuum source 164, a second vacuum source 166, and a set of two-way pneumatic control valves 162-1, 162-2, 163-3, 170, 172 for alternately connecting the holders 150-1, 150-2, 150-3 of the post-mold device to one of the first vacuum source 164 and the second vacuum source 166. Of course, other types and combination of control valves may be used to accomplish the same pneumatic connections, as detailed hereinafter. For example, the set of two-way control valves 162-1, 162-2, 163-3, 170, 172 could be replaced with a combination of three-way valves, or a single valve could be used, if available, having corresponding number of valve positions. The first set of valves 162-1, 162-2, 162-3 are controllable, by molding machine controller 30, for connecting the holders 150-1, 150-2, 150-3 with one of: (i) the first vacuum source 164; and (ii) a second control valve 170. The second control valve 170 is controllable, by the molding machine controller 30, for connecting the first valves 162-1, 162-2, 162-3 with one of: i) the second vacuum source 166; and (ii) a third control valve 172. The third control valve 172 is controllable, by the molding machine controller 30, for connecting the second valve 170 with one of: (i) a pressure source 176 (i.e. pneumatic overpressure); and (ii) an atmospheric pressure source 174. In so doing, the controller 30 can configure the valves 162-1, 162-2, 162-3, 170, 172 to connect each of the holders 150-1, 150-2, 150-3 to any one of the first and second vacuum sources 164, 166, the pressure source 176, and the atmospheric pressure source 174.

Preferably, the first and second vacuum sources 164, 166 includes vacuum tanks connected to a vacuum pump 178 for the sake of maintaining a predetermined vacuum pressure therein. Preferably, a check valve 168 separates the first and second vacuum sources 164, 166, the check valve being oriented to prevent overpressure in the second vacuum source 166, relative to the first vacuum source 164, from pressurizing the first vacuum source 164. In particular, it is economically advantageous to configure the second vacuum source 166 to have a much larger volumetric capacity than the first vacuum source 164, whereby the second vacuum source 166, during normal operation of the post-mold device, is used primarily for drawing a predetermined vacuum pressure in the holder 150-1, 150-2, 150-3, before the evacuated holder 150-1, 150-2, 150-3 is connected to the smaller first vacuum source 164 for maintaining, or further adjusting, the predetermined vacuum pressure. Accordingly, the check valve 168 is preferably oriented to prevent the loss of vacuum pressure from the first vacuum source 164 to the second vacuum source 166.

In accordance with an alternative embodiment of the pneumatic structure 160 (not shown), at least one of the first and second vacuum sources 164, 166 include a vacuum pump 178.

In operation, a method of controlling a pneumatic structure 160 for a post-mold device preferably includes the steps of: (i) configuring the control valves 162-1, 162-2, 162-3, 170, 172 to connect a holder 150-1, 150-2, 150-3 of the post-mold device to one of a first and second vacuum source 164, 166 for receiving a molded article therein; (ii) drawing a predetermined vacuum pressure in the occupied holder 150-1, 150-2, 150-3 using the one of the first and second vacuum source 164, 166; (iii) configuring the control valves 162-1, 162-2, 162-3, 170, 172 to connect the respective holder 150-1, 150-2, 150-3 of the post-mold device to the other one of the first and second vacuum source 164, 166; and (iv) controlling the vacuum pressure in the holder 150-1, 150-2, 150-3 using the other of the first and second vacuum source 164, 166. The process may also include the subsequent step(s) of configuring the control valves 162-1, 162-2, 162-3, 170, 172 to isolate the respective holder 150-1, 150-2, 150-3 from the first and second vacuum source 164, 166 and to connect the respective holder 150-1, 150-2, 150-3 to one of the pressure source 176 and the atmospheric pressure source 174, for example, to effect a pressure induced mobility of a molded article 2 and/or to condition the respective holder 150-1, 150-2, 150-3 (e.g. cleanse the pores of the porous member).

Where the post-mold device includes a plurality of holder stages the method preferably includes the steps of connecting one of the first and second vacuum sources 164, 166 to a holder 150-1, 150-2, 150-3 of at least one of the plurality of holder stages for drawing an initial predetermined vacuum pressure in the holder 150-1, 150-2, 150-3, and thereafter the holder 150-1, 150-2, 150-3 of the at least one of the plurality of holder stages is switched to the other one of the first and second vacuum sources 164, 166, for sustaining the vacuum pressure in the holder 150-1, 150-2, 150-3 thereof, as a holder 150-1, 150-2, 150-3 of another of the plurality of holder stages is connected to the one of the first and second vacuum sources 164, 166 for drawing a predetermined vacuum pressure therein.

With reference to the remaining FIGS. 4 through 27, the operation of the pneumatic structure 160 of the presently preferred embodiment is depicted during an initial start-up operation, and thereafter during normal operation.

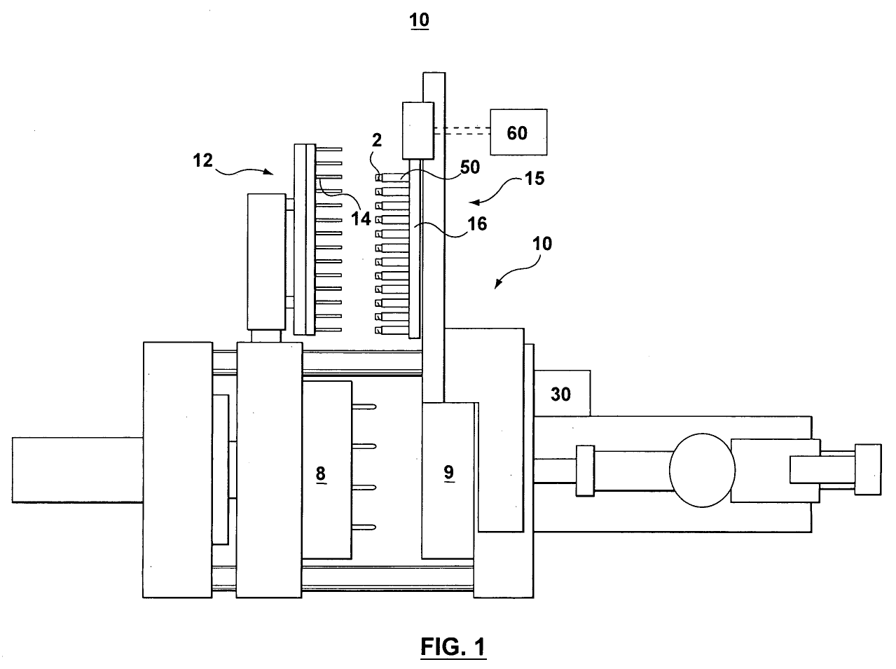

FIG. 4 depicts the pneumatic structure 160 of FIG. 3 with the valves 162-1, 162-2, 162-3, 170, 172 configured to connect the empty holders 150-1, 150-2, 150-3 of the multi-stage post-mold device to a pressure source 176, during start-up operation, for the sake of cleansing the pores of the porous member, of the holders 150-1, 150-2, 150-3, by means of a pneumatic overpressure. The vacuum tanks of the first and second vacuum source 164, 166 are preferably evacuated during this period by vacuum pump 178. During this period the post-mold device is moved to an in-mold position to receive molded articles 2 from the mold 8, 9 (FIG. 1).

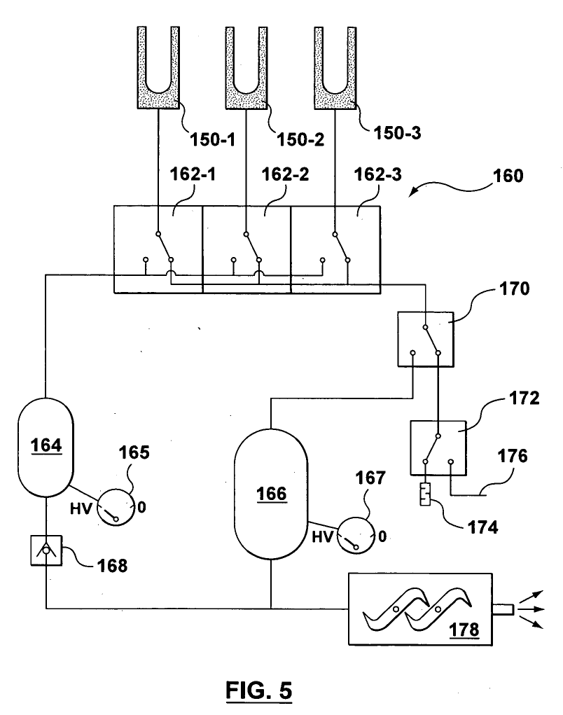

FIG. 5 depicts the pneumatic structure 160 of FIG. 3 with the valves 162-1, 162-2, 162-3, 170, 172 configured to switch the holders 150-1, 150-2, 150-3 to a connection with the atmospheric pressure source 174, during start-up operation, prior to a transfer of a molded article 2 into the holder 150-1 of a first stage of the post-mold device. During this stage of operation, the post-mold device stops in the in-mold position adjacent the mold 8, 9 (FIG. 1).

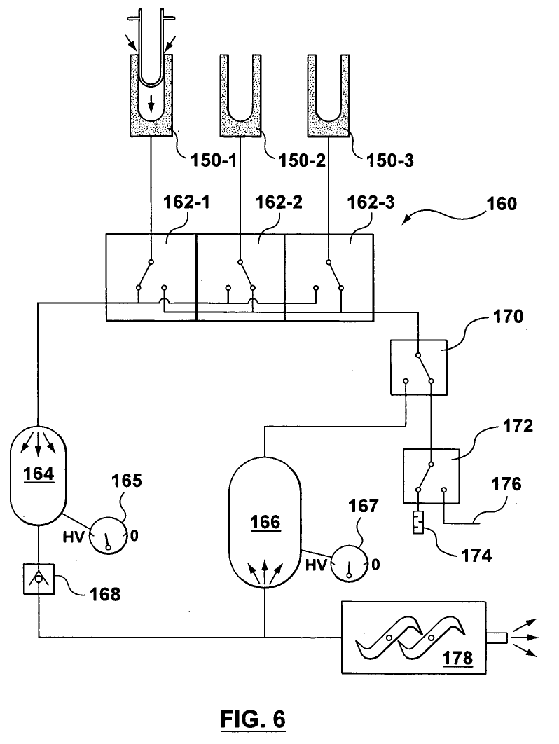

FIG. 6 depicts the pneumatic structure 160 of FIG. 3 with the valves 162-1, 162-2, 162-3, 170, 172 configured to switch the holder 150-1 of the first stage to the first vacuum source 164, during start-up operation, for the sake of receiving the molded article 2 in the holder 150-1 and for achieving a predetermined vacuum pressure therein. During this step of operation it is expected that the vacuum pressure will drop in both tanks.

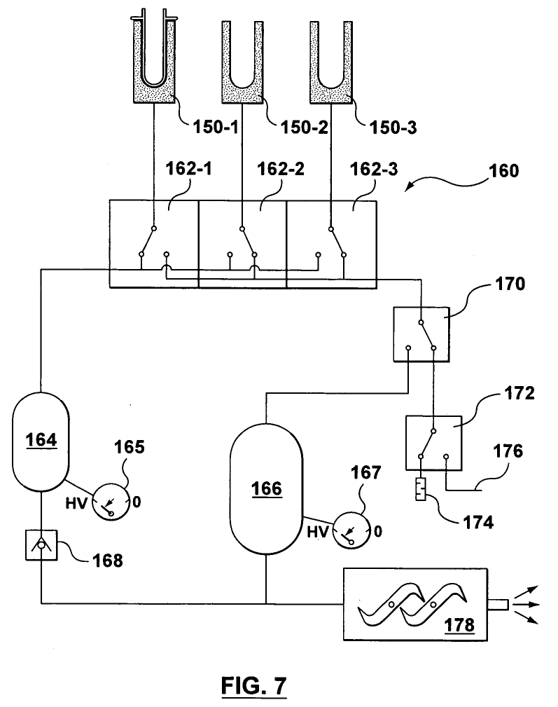

FIG. 7 depicts the pneumatic structure 160 of FIG. 3 with the valves 162-1, 162-2, 162-3, 170, 172 after the receipt of the molded article 2 into the holder 150-1 of the first stage of the post-mold device, during start-up operation, as the first and second vacuum sources 164, 166 are evacuated by the vacuum pump 178. During this step of operation, the post-mold device is moved to an outboard position away from the mold 8, 9 where it may dwell, as required, subsequently the post-mold device then starts moving back to the in-mold position.

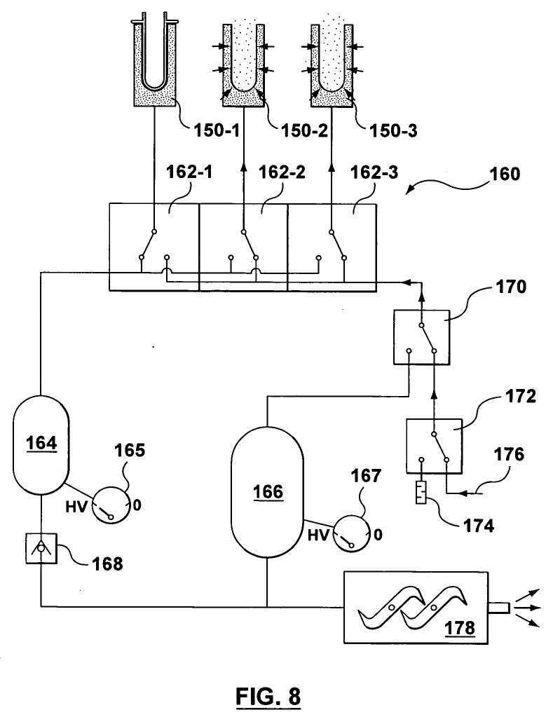

FIG. 8 depicts the pneumatic structure 160 of FIG. 3 with the valves 162-1, 162-2, 162-3, 170, 172 configured to switch the empty holders 150-2, 150-3 of the second and third stages of the post-mold device to the pressure source 176, during start-up operation, to cleanse the pores of the porous member of the holders 150-2, 150-3.

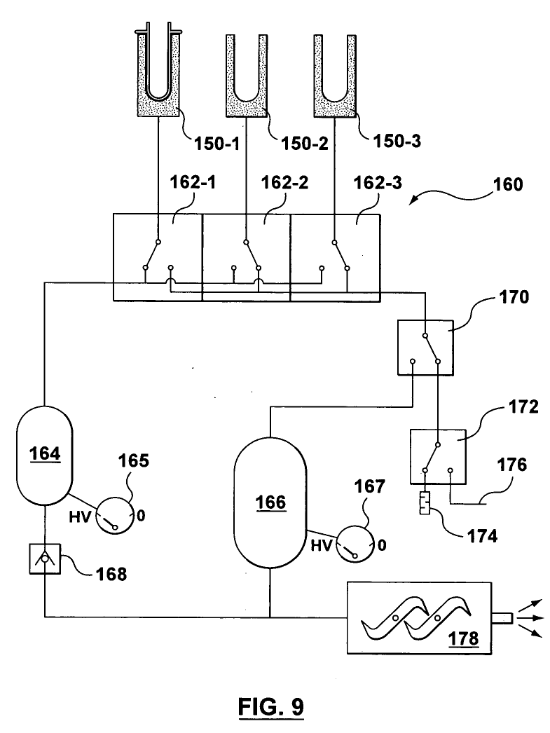

FIG. 9 depicts the pneumatic structure 160 of FIG. 3 with the valves 162-1, 162-2, 162-3, 170, 172 configured to switch the empty holders 150-2, 150-3 of the second and third stages of the post-mold device to the atmospheric pressure source 174, during start-up operation, prior to a transfer of a molded article 2 into the holder 150-2 of the second stage of the post-mold device. During this stage of operation, the post-mold device stops in the in-mold position adjacent the mold 8, 9 (FIG. 1).

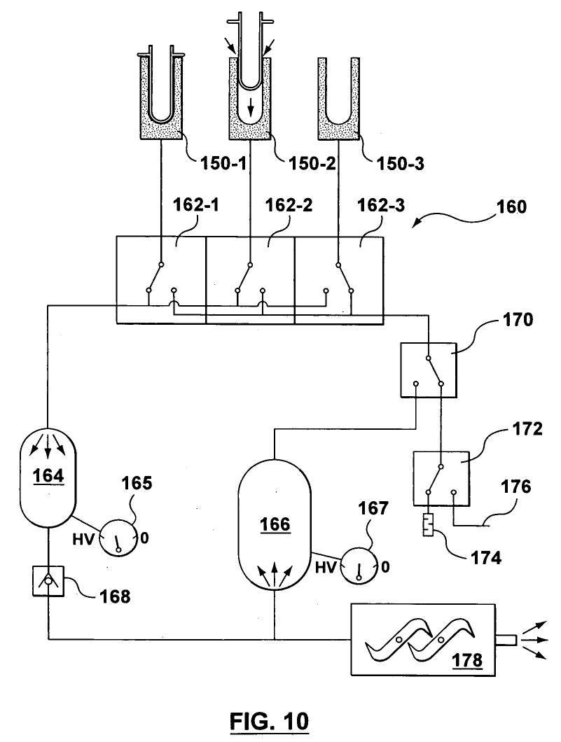

FIG. 10 depicts the pneumatic structure 160 of FIG. 3 with the valves 162-1, 162-2, 162-3, 170, 172 configured to switch the holder 150-2 of the second stage to the first vacuum source 164, during start-up operation, for the sake of receiving the molded, article 2 in the holder 150-2 and for achieving a predetermined vacuum pressure therein. During this step of operation it is expected that the vacuum pressure will drop in both tanks.

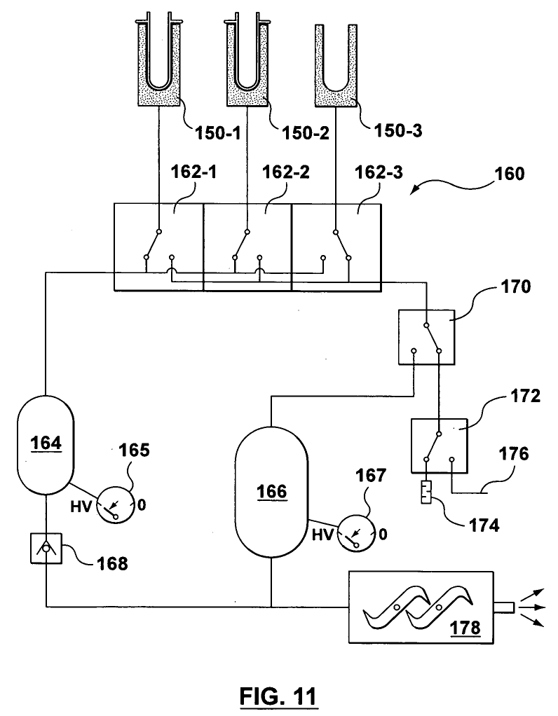

FIG. 11 depicts the pneumatic structure 160 of FIG. 3 with the valves 162-1, 162-2, 162-3, 170, 172 after the receipt of the molded article 2 into the holder 150-2 of the second stage of the post-mold device, during start-up operation, as the first and second vacuum sources 164, 166 are evacuated by the vacuum pump 178. During this step of operation, the post-mold device is moved to an outboard position away from the mold 8, 9 where it may dwell, as required, subsequently the post-mold device then starts moving back to the in-mold position.

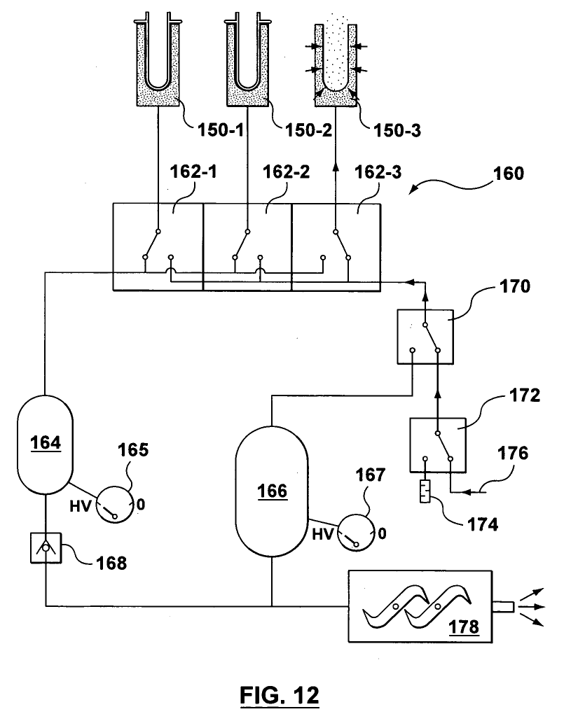

FIG. 12 depicts the pneumatic structure 160 of FIG. 3 with the valves 162-1, 162-2, 162-3, 170, 172 configured to switch the empty holder 150-3 of the third stage of the post-mold device to the pressure source 176, during start-up operation, to cleanse the pores of the porous member of the holder 150-3.

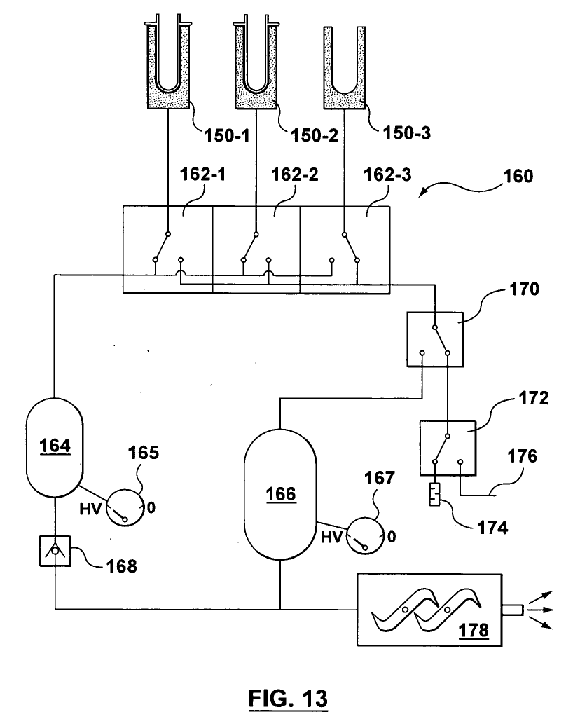

FIG. 13 depicts the pneumatic structure 160 of FIG. 3 with the valves 162-1, 162-2, 162-3, 170, 172 configured to switch the empty holder 150-3 of the third stage of the post-mold device to the atmospheric pressure source 174, during start-up operation, prior to a transfer of a molded article 2 into the holder 150-3 of the third stage of the post-mold device. During this stage of operation, the post-mold device stops in the in-mold position adjacent the mold 8, 9 (FIG. 1).

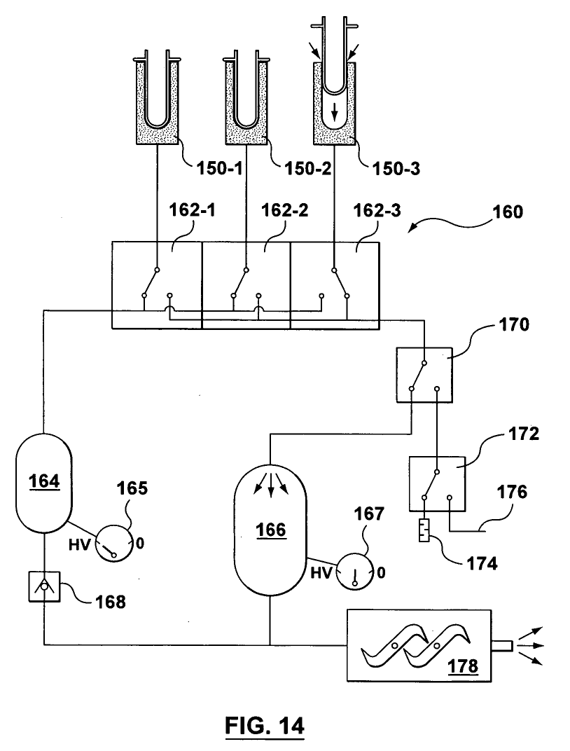

FIG. 14 depicts the pneumatic structure 160 of FIG. 3 with the valves 162-1, 162-2, 162-3, 170, 172 configured to switch the holder 150-3 of the third stage to the second vacuum source 166 alone, during normal operation, for the sake of receiving the molded article 2 in the holder 150-3 and for achieving a predetermined vacuum pressure therein.

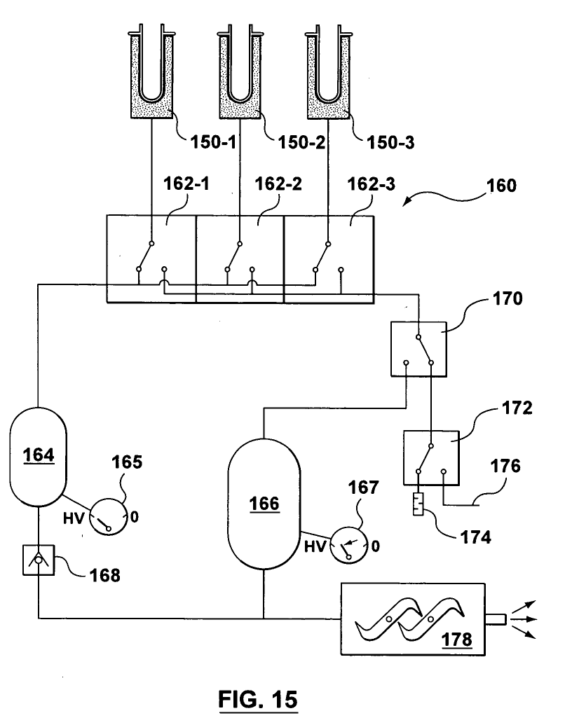

FIG. 15 depicts the pneumatic structure 160 of FIG. 3 with the valves 162-1, 162-2, 162-3, 170, 172 configured to switch the holder 150-3 of the third stage to the first vacuum source 164, during normal operation, to maintain, or further adjust, the vacuum pressure in the holder 150-3 of the third stage. During this stage of operation, the second vacuum source 166 is preferably evacuated by the vacuum pump 178.

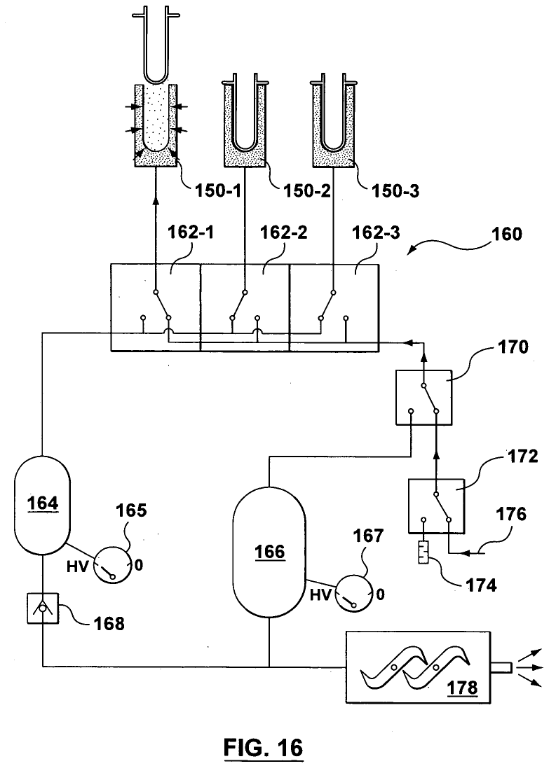

FIG. 16 depicts the pneumatic structure 160 of FIG. 3 with the valves 162-1, 162-2, 162-3, 170, 172 configured to switch the holder 150-1 of the first stage of the post-mold device to the pressure source 176, during normal operation, to assist with the release of the molded article 2 from the holder 150-1 and to cleanse the pores of the porous member of the holder 150-1.

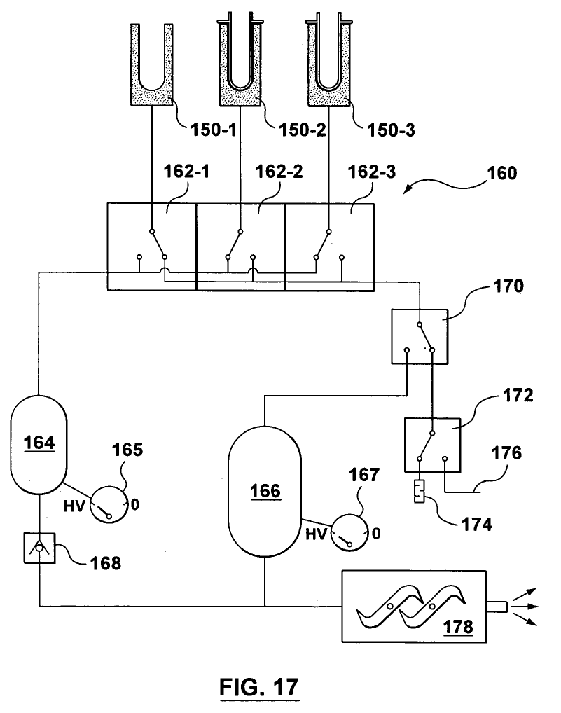

FIG. 17 depicts the pneumatic structure 160 of FIG. 3 with the valves 162-1, 162-2, 162-3, 170, 172 configured to switch the empty holder 150-1 of the first stage of the post-mold device to the atmospheric pressure source 174, during normal operation, prior to a transfer of the next molded article 2 into the holder 150-1 of the first stage of the post-mold device. During this stage of operation, the post-mold device stops in the in-mold position adjacent the mold 8, 9 (FIG. 1).

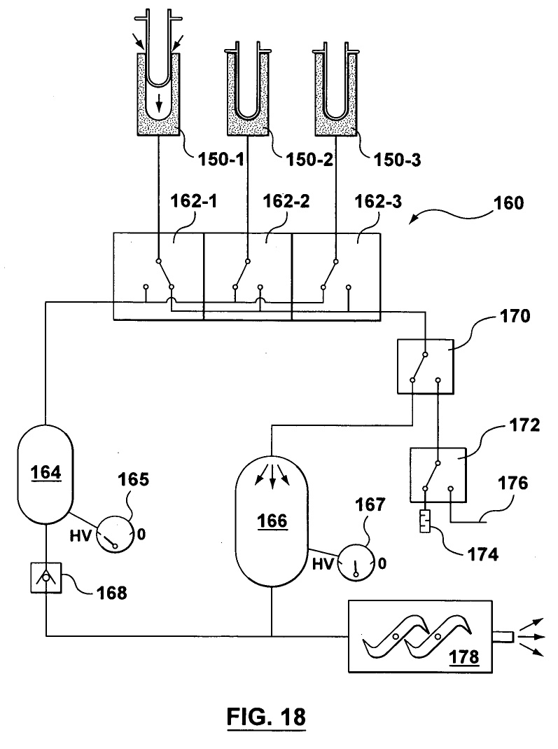

FIG. 18 depicts the pneumatic structure 160 of FIG. 3 with the valves 162-1, 162-2, 162-3, 170, 172 configured to switch the holder 150-1 of the first stage to the second vacuum source 166 alone, during normal operation, for the sake of receiving the molded article 2 in the holder 150-1 and for achieving a predetermined vacuum pressure therein.

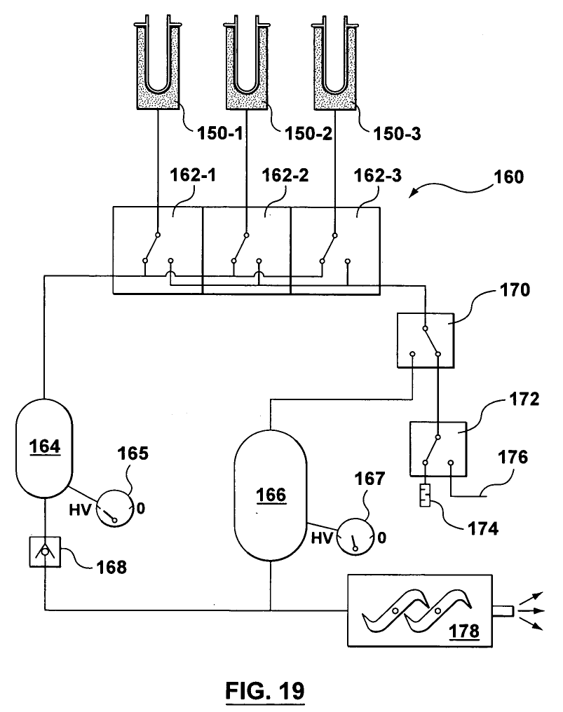

FIG. 19 depicts the pneumatic structure 160 of FIG. 3 with the valves 162-1, 162-2, 162-3, 170, 172 configured to switch the holder 150-1 of the first stage to the first vacuum source 164, during normal operation, to maintain, or further adjust, the vacuum pressure in the holder 150-1 of the first stage. During this stage of operation, the second vacuum source 166 is preferably evacuated by the vacuum pump 178.

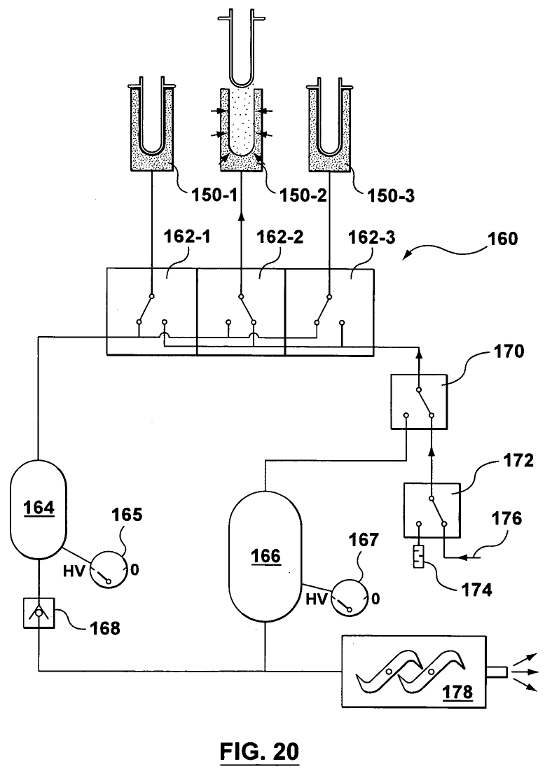

FIG. 20 depicts the pneumatic structure 160 of FIG. 3 with the valves 162-1, 162-2, 162-3, 170, 172 configured to switch the holder 150-2 of the second stage of the post-mold device to the pressure source 176, during normal operation, to assist with the release of the molded article 2 from the holder 150-2 and to cleanse the pores of the porous member of the holder 150-2.

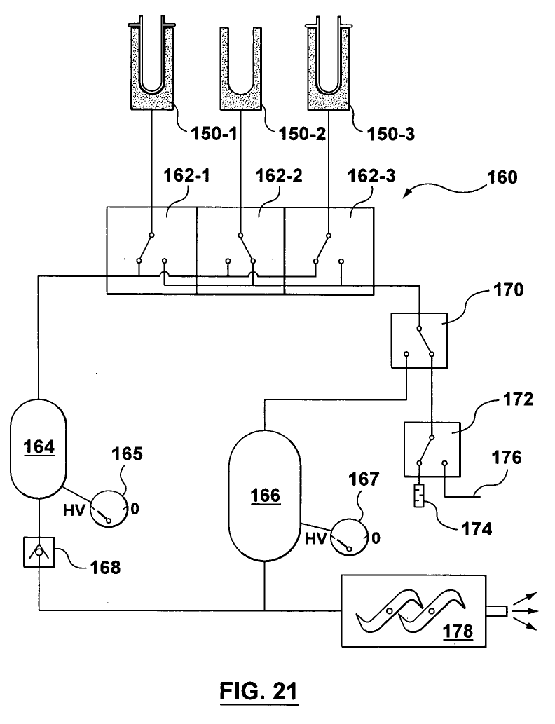

FIG. 21 depicts the pneumatic structure 160 of FIG. 3 with the valves 162-1, 162-2, 162-3, 170, 172 configured to switch the empty holder 150-2 of the second stage of the post-mold device to the atmospheric pressure source 174, during normal operation, prior to a transfer of the next molded article 2 into the holder 150-2 of the second stage of the post-mold device. During this stage of operation, the post-mold device stops in the in-mold position adjacent the mold 8, 9 (FIG. 1).

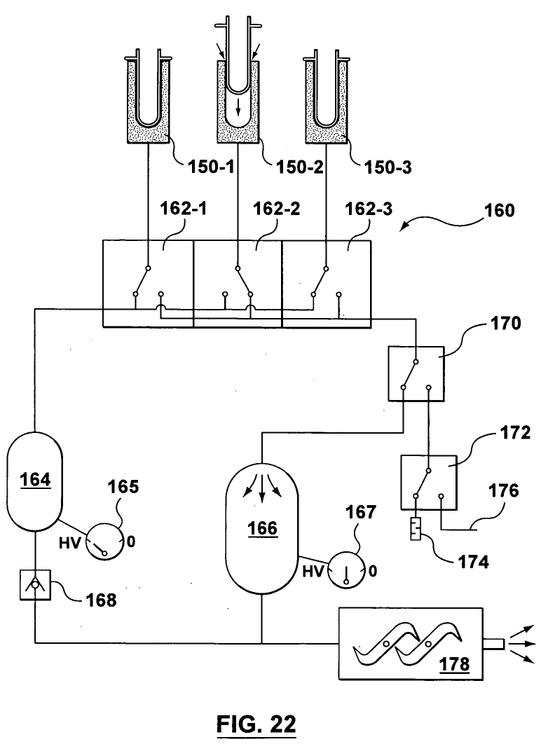

FIG. 22 depicts the pneumatic structure 160 of FIG. 3 with the valves 162-1, 162-2, 162-3, 170, 172 configured to switch the holder 150-2 of the second stage to the second vacuum source 166 alone, during normal operation, for the sake of receiving the molded article 2 in the holder 150-2 and for achieving a predetermined vacuum pressure therein.

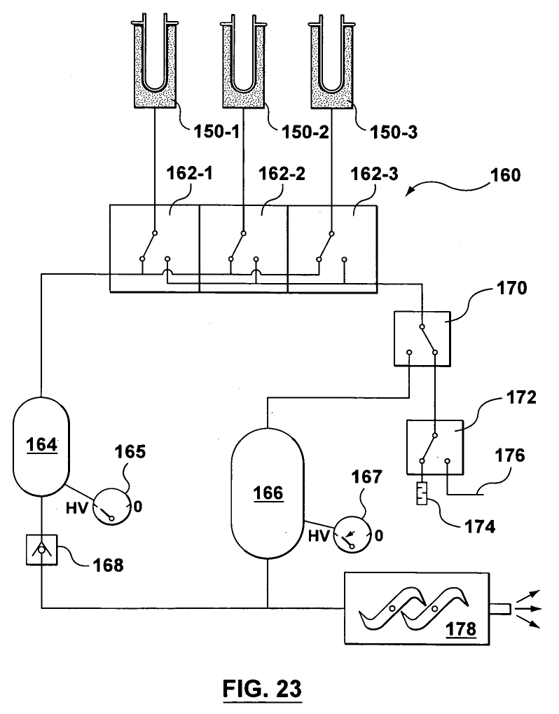

FIG. 23 depicts the pneumatic structure 160 of FIG. 3 with the valves 162-1, 162-2, 162-3, 170, 172 configured to switch the holder 150-2 of the second stage to the first vacuum source 164, during normal operation, to maintain, or further adjust, the vacuum pressure in the holder 150-2 of the second stage. During this stage of operation, the second vacuum source 166 is preferably evacuated by the vacuum pump 178.

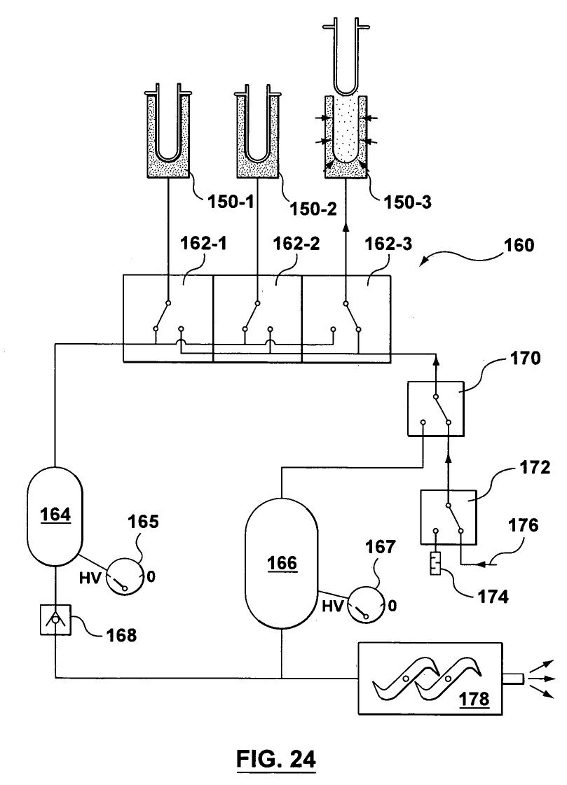

FIG. 24 depicts the pneumatic structure 160 of FIG. 3 with the valves 162-1, 162-2, 162-3, 170, 172 configured to switch the holder 150-3 of the third stage of the post-mold device to the pressure source 176, during normal operation, to assist with the release of the molded article 2 from the holder 150-3 and to cleanse the pores of the porous member of the holder 150-3.

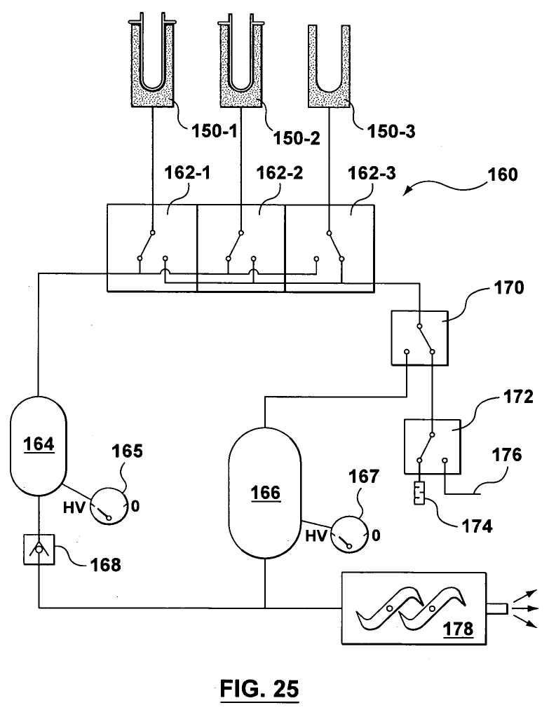

FIG. 25 depicts the pneumatic structure 160 of FIG. 3 with the valves 162-1, 162-2, 162-3, 170, 172 configured to switch the empty holder 150-3 of the third stage of the post-mold device to the atmospheric pressure source 174, during normal operation, prior to a transfer of the next molded article 2 into the holder 150-3 of the third stage of the post-mold device. During this stage of operation, the post-mold device stops in the in-mold position adjacent the mold 8, 9 (FIG. 1).

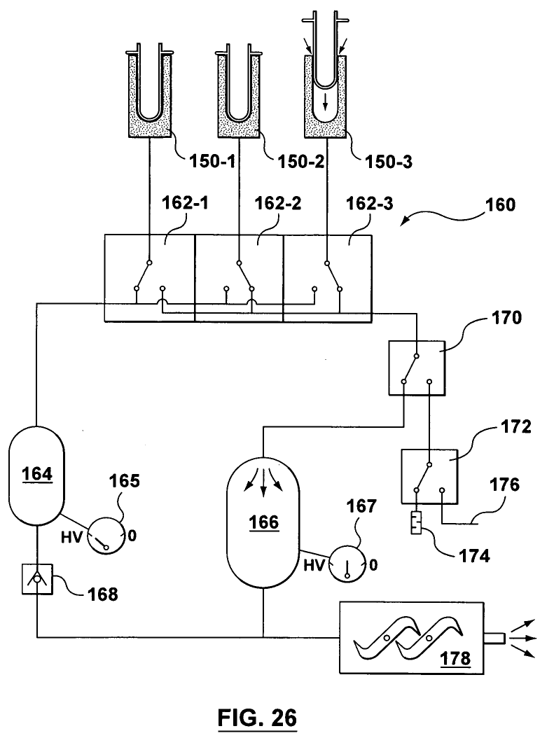

FIG. 26 depicts the pneumatic structure 160 of FIG. 3 with the valves 162-1, 162-2, 162-3, 170, 172 configured to switch the holder 150-3 of the third stage to the second vacuum source 166 alone, during normal operation, for the sake of receiving the molded article 2 in the holder 150-3 and for achieving a predetermined vacuum pressure therein.

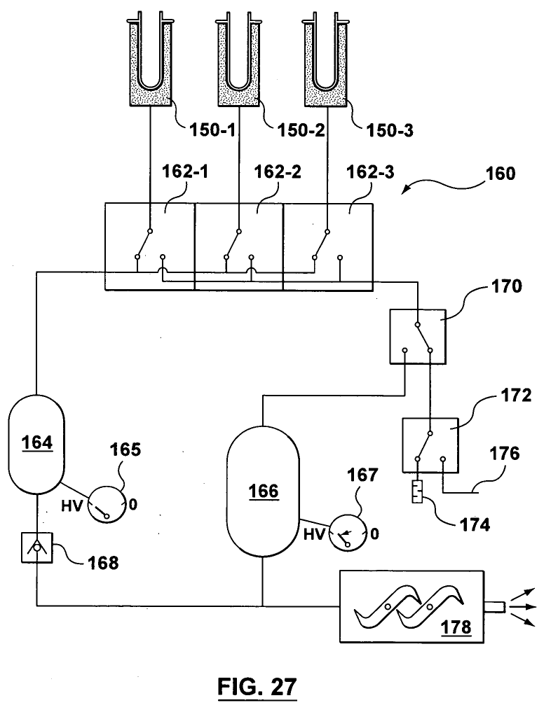

FIG. 27 depicts the pneumatic structure 160 of FIG. 3 with the valves 162-1, 162-2, 162-3, 170, 172 configured to switch the holder 150-3 of the third stage to the first vacuum source 164, during normal operation, to maintain, or further adjust, the vacuum pressure in the holder 150-3 of the third stage. During this stage of operation, the second vacuum source 166 is preferably evacuated by the vacuum pump 178.

The operation of the pneumatic structure 160 then continues to cycle in accordance with the normal mode of operation.

A technical effect of the preferred embodiment of the present invention, amongst others, is a pneumatic structure 160 that isolates the holders 150-1, 150-2, 150-3 of the post-mold device, occupied by molded articles 2, from vacuum pressure variations for the sake of avoiding cooling related defects in the molded article 2.

Another technical effect, amongst others, of the preferred embodiment includes a cost effective pneumatic structure 160 that avoids having a dedicated vacuum source for each stage of the post-mold device, and that may also operate using a single vacuum pump 178.

In accordance with the forgoing it is preferred, but not necessary, to completely disconnect one of the first vacuum source 164, second vacuum source 166, pressure source 176, and the atmospheric pressure source 174 from the holder 150 before connecting another one thereof. Hence, it would be within the scope of the exemplary embodiment that the control valve 162, 170, 172 may simultaneously connect more than one of one of the first vacuum source 164, second vacuum source 166, pressure source 176, and the atmospheric pressure source 174 to the holder 150 of the device 115 for a transitory moment of time while switching therebetween.

The description of the exemplary embodiments provides examples of the present invention, and these examples do not limit the scope of the present invention. It is understood that the scope of the present invention is limited by the claims. The concepts described above may be adapted for specific conditions and/or functions, and may be further extended to a variety of other applications that are within the scope of the present invention. Having thus described the exemplary embodiments, it will be apparent that modifications and enhancements are possible without departing from the concepts as described. Therefore, what is to be protected by way of letters patent are limited only by the scope of the following claims:

What is claimed is:

1. A pneumatic structure of a post-mold device comprising:
a control valve configured to alternately pneumatically connect a holder of the post-mold device to one of: a first vacuum source; and a second vacuum source.

2. The pneumatic structure of claim 1, wherein:
the control valve configured to alternately pneumatically connect the holder of the post-mold device to a selected one of: the first vacuum source; the second vacuum source; and a pressure source.

3. The pneumatic structure of claim 1, wherein:
the control valve alternately connecting the holder of the post-mold device to a selected one of: the first vacuum source; the second vacuum source; and an atmospheric pressure source.

4. The pneumatic structure of claim 1, further comprising:
the first and second vacuum sources.

5. The pneumatic structure of claim 2, further comprising:
the pressure source.

6. The pneumatic structure of claim 3, further comprising:
the atmospheric source.

7. The pneumatic structure of claim 4, wherein:
at least one of the first and second vacuum sources includes a vacuum pump.

8. The pneumatic structure of claim 4, wherein:
at least one of the first and second vacuum sources includes a vacuum tank connectable to a vacuum pump.

9. The pneumatic structure of claim 4, wherein:
the first and second vacuum sources includes a pair of vacuum tanks that are connected to a common vacuum pump, and wherein a check valve separates the first and second vacuum sources, the check valve being oriented to prevent overpressure in one of the vacuum sources from pressurizing the other.

10. A method of a post-mold device in a molding system, the method comprising:
configuring a control valve for alternately pneumatically connecting a holder of the post-mold device between a first vacuum source and to a second vacuum source.

11. The method of claim 8, further comprising:
receiving a molded article in the holder;
drawing a predetermined vacuum pressure in the occupied holder using the one of the first and second vacuum source;
configuring the control valve to connect the holder of the post-mold device to the other one of the first and second vacuum source; and
controlling the vacuum pressure in the holder using the other of the first and second vacuum source.

12. The method of claim 8, further comprising:
configuring the control valve for: (i) isolating the holder from the first and second vacuum source; and (ii) connecting the holder to a pressure source.

13. The method of claim 8, further comprising:
configuring the control valve for: (i) isolating the holder from the first and second vacuum source; and (ii) connecting the holder to an atmospheric pressure source.

14. The method of claim 8, wherein the post-mold device includes a plurality of holder stages and the method further comprises:
connecting one of the first and second vacuum sources to a holder of at least one of the plurality of holder stages for drawing an initial predetermined vacuum pressure in the holder; and
switching thereafter the holder of the at least one of the plurality of holder stages to the other one of the first and second vacuum sources, for sustaining the vacuum pressure in the holder thereof, as a holder of another of the plurality of holder stages is connected to the one of the first and second vacuum sources for drawing a predetermined vacuum pressure therein.

15. A post-mold device, comprising:
a molded article holder; and
a pneumatic structure, including a controllable valve configured to alternately pneumatically connect the post-mold device between a first vacuum source and to a second vacuum source.

16. The post-mold device of claim 15, wherein:
the control valve configured to alternately pneumatically connect the holder of the post-mold device to a selected one of: the first vacuum source; the second vacuum source; and a pressure source.

17. The post-mold device of claim 15, wherein:
the control valve alternately connecting the holder of the post-mold device to a selected one of: the first vacuum source; the second vacuum source; and an atmospheric pressure source.

18. The post-mold device of claim 15, further comprising:
the first and second vacuum sources.

19. The post-mold device of claim 16, further comprising:
the pressure source.

20. The post-mold device of claim 17, further comprising:
the atmospheric source.

21. The post-mold device of claim 18, wherein:
at least one of the first and second vacuum sources includes a vacuum pump.

22. The post-mold device of claim 18, wherein:
at least one of the first and second vacuum sources includes a vacuum tank connectable to a vacuum pump.

23. The post-mold device of claim 18, wherein:
the first and second vacuum sources includes a pair of vacuum tanks that are connected to a common vacuum pump, and wherein a check valve separates the first and second vacuum sources, the check valve being oriented to prevent overpressure in one of the vacuum sources from pressurizing the other.

24. A molding system, comprising:
a post-mold device, including a holder; and
a pneumatic structure, including a controllable valve configured to alternately pneumatically connect the post-mold device between a first vacuum source and to a second vacuum source.

25. The molding system of claim 24, wherein:
the control valve configured to alternately pneumatically connect the holder of the post-mold device to a selected one of: the first vacuum source; the second vacuum source; and a pressure source.

26. The molding system of claim 24, wherein:
the control valve alternately connecting the holder of the post-mold device to a selected one of: the first vacuum source; the second vacuum source; and an atmospheric pressure source.

27. The molding system of claim 24, further comprising:
the first and second vacuum sources.

28. The molding system of claim 25, further comprising:
the pressure source.

29. The molding system of claim 26, further comprising:
the atmospheric source.

30. The molding system of claim 27, wherein:
at least one of the first and second vacuum sources includes a vacuum pump.

31. The molding system of claim 27, wherein:
at least one of the first and second vacuum sources includes a vacuum tank connectable to a vacuum pump.

32. The molding system of claim 27, wherein:
the first and second vacuum sources includes a pair of vacuum tanks that are connected to a common vacuum pump, and wherein a check valve separates the first and second vacuum sources, the check valve being oriented to prevent overpressure in one of the vacuum sources from pressurizing the other.
